(19) United States
(12) Patent Application Publication
(10) Pub. No.: US 2022/0379301 A1
(43) Pub. Date: Dec. 1, 2022

(54) Specimen Transport Tube Rack Cap

(71) Applicant: Lauren Cooper, Indianapolis, IN (US)

(72) Inventor: Lauren Cooper, Indianapolis, IN (US)

(21) Appl. No.: 17/334,944

(22) Filed: May 31, 2021

(51) Int. Cl. B01L 3/00

(52) U.S. Cl. CPC B01L 3/50825; B01L 2300/042

(57) ABSTRACT

An article of manufacture for a reusable specimen transport tube rack cap that secures specimen collection swabs inside of transport tubes is disclosed. The reusable specimen transport tube rack cap includes a top surface connecting a plurality of specimen tube caps in a row, a bottom surface having a circular inner wall and a circular outer wall creating a specimen retention ridges defining a cap for each specimen tube, and access hole through each reusable specimen transport tube rack cap between the inner wall and the outer wall for providing access for a pipette into a specimen tube.

### TECHNICAL FIELD

This application relates in general to an article of manufacture for providing an automated medical testing aid, and more specifically, to an article of manufacture providing a reusable specimen transport tube rack cap that secures specimen collection swabs inside of transport tubes.

### BACKGROUND

Swabs used for the collection of patient samples for the detection of SARS-CoV-2, the causative agent of COVID-19, are placed in tubes with media for transport to the laboratory for testing. Once these tubes come to the laboratory, the swabs must be manually removed before samples can be placed on automated liquid handling platforms (i.e., Hamilton Vantage™, ThermoFisher Teacan™, etc.) for automated aliquoting and testing. This removal is required as swabs can stick to the pipette tip during media removal, and result in contamination of the liquid handler or other patient specimens. Due to the need to de-swab, numerous staff members need to be allocated for this task, increasing cost and decreasing testing throughput. Many types of transport media also require the swab to be removed in a biosafety cabinet (BSC), as some media are not able to neutralize pathogens. During this pandemic, BSCs are in extreme short supply in comparison to the demand based on the requirement of de-swabbing samples.

Therefore, a need exists for an article of manufacture for providing a reusable specimen transport tube rack cap that secures specimen collection swabs inside of transport tubes. The present invention attempts to address the limitations and deficiencies in prior solutions according to the principles and example embodiments disclosed herein.

### SUMMARY

In accordance with the present invention, the above and other problems are solved by providing an article of manufacture for a reusable specimen transport tube rack cap that secures specimen collection swabs inside of transport tubes according to the principles and example embodiments disclosed herein.

In one embodiment, the present invention is an article of manufacture for providing a reusable specimen transport tube rack cap that secures specimen collection swabs inside of transport tubes. The reusable specimen transport tube rack cap includes a top surface connecting a plurality of specimen tube caps in a row, a bottom surface having a circular inner wall and a circular outer wall creating a specimen retention ridges defining a cap for each specimen tube, and access hole through each reusable specimen transport tube rack cap between the inner wall and the outer wall for providing access for a pipette into a specimen tube.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It also should be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1a-b illustrate top and bottom views of an example embodiment of an article of manufacture providing a reusable specimen transport tube rack cap that secures specimen collection swabs inside of transport tubes according to the present invention.

FIGS. 2a-b illustrate close-up top and bottom views of an article of manufacture providing a reusable specimen transport tube rack cap that secures specimen collection swabs inside of transport tubes according to the present invention.

FIGS. 3a-b illustrate dimensions of an example embodiment of an article of manufacture providing a reusable specimen transport tube rack cap that secures specimen collection swabs inside of transport tubes according to the present invention.

FIGS. 4a-c illustrate another embodiment of an article of manufacture providing a reusable specimen transport tube rack cap that secures specimen collection swabs inside of transport tubes according to the present invention.

FIGS. 5a-b illustrate transport tubes using an article of manufacture providing a reusable specimen transport tube rack cap that secures specimen collection swabs inside of transport tubes according to the present invention.

### DETAILED DESCRIPTION

This application relates in general to an article of manufacture for providing an automated medical testing aids and more specifically, to an article of manufacture for providing a reusable specimen transport tube rack cap that secures specimen collection swabs inside of transport tubes according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “worker” and “user” refer to an entity, e.g., a human, using a reusable specimen transport tube rack cap that secures specimen collection swabs inside of transport tubes associated with the invention. The term user herein refers to one or more users.

The term “invention” or “present invention” refers to the invention being applied for via the patent application with the title “Specimen Transport Tube Rack Cap.” Invention may be used interchangeably with tube caps.

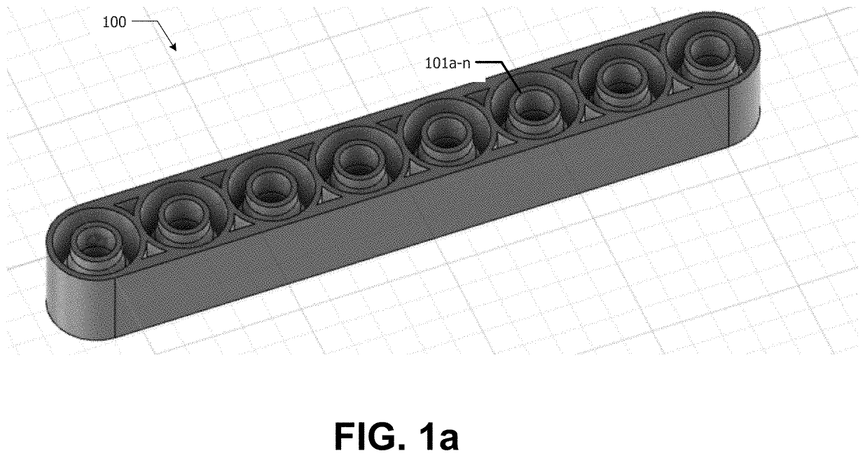

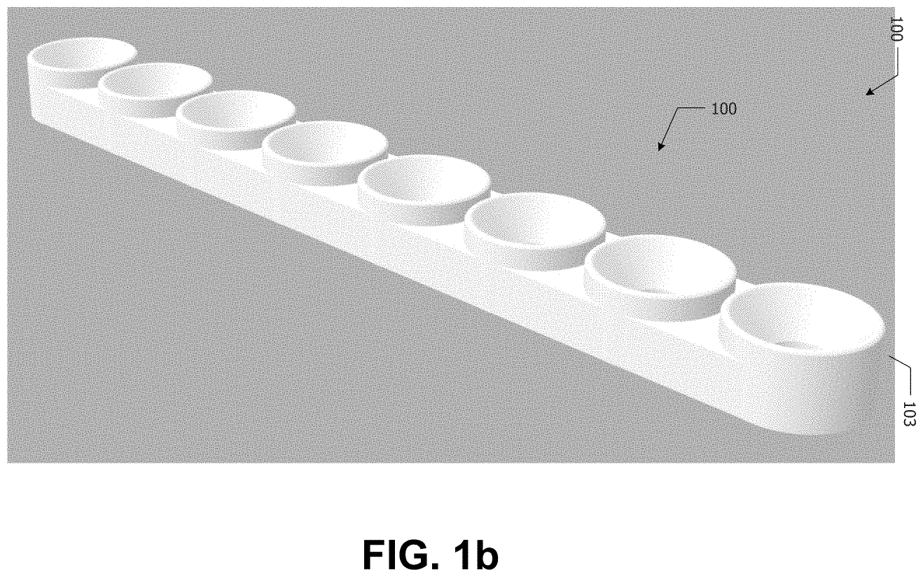

In general, the present disclosure relates to an article of manufacture for providing a reusable specimen transport tube rack cap that secures specimen collection swabs inside of transport tubes. To better understand the present invention, FIGS. 1a-b illustrate top and bottom views of an example embodiment of an article of manufacture providing a reusable specimen transport tube rack cap that secures specimen collection swabs inside of transport tubes according to the present invention. FIG. 1a shows a bottom view of a specimen transport tube rack cap 100 and FIG. 1b shows a top view of the specimen transport tube rack cap 100.

The specimen transport tube rack cap 100 offers an additional product that can be used to secure specimen collection swabs inside individual, strips, and/or blocks of specimen transport tubes during automated pipetting by liquid handlers. These racks can be constructed out of any material that can either be autoclaved or bleached for reuse. The specimen transport tube rack cap 100 may comprise any number of specimen transport tube caps 101a-n to match with the number and spacing of the specimen tubes used by an automated sample processing system. The specimen transport tube rack cap 100 may be installed at the time and location that the samples are obtained or may be installed at the testing laboratory.

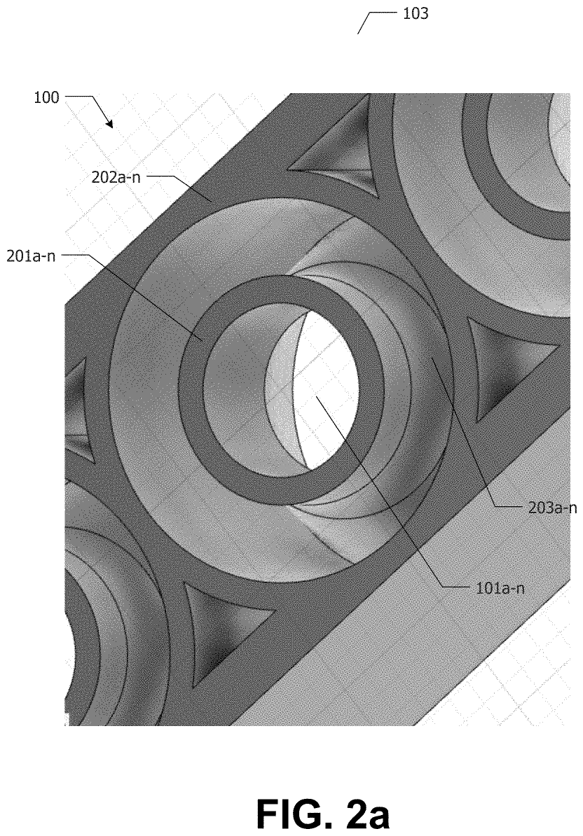

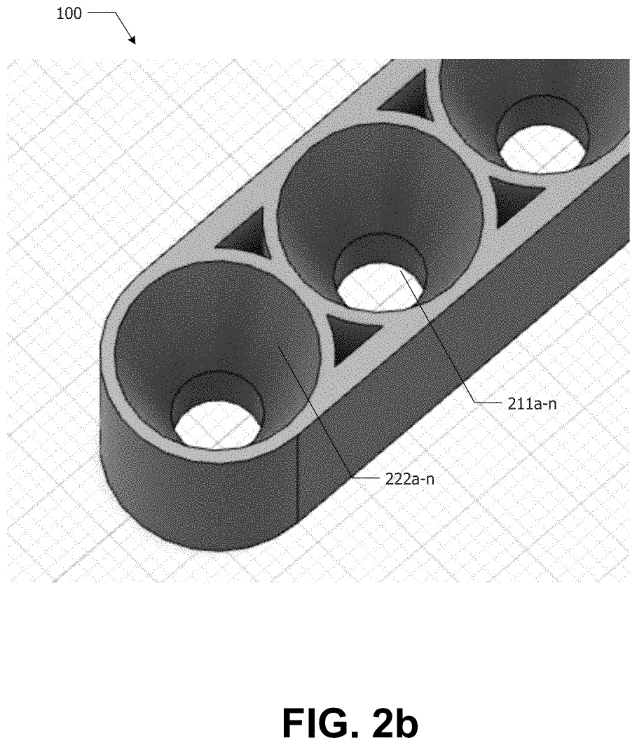

FIGS. 2a-b illustrate close-up top and bottom views of an article of manufacture providing a reusable specimen transport tube rack cap that secures specimen collection swabs inside of transport tubes according to the present invention. FIG. 2a shows a close-up of the bottom view of a specimen transport tube rack cap 100. FIG. 2b shows a close-up of the top view of the specimen transport tube rack cap 100.

This specimen transport tube rack cap 100 is a single piece of material containing one or more transport tube caps 101a-n. The bottom side of the specimen transport tube rack cap 100 shown in FIG. 2a contains specimen retention ridges 203a-n having an inner wall 201a-n and an outer wall 202a-n that allow the specimen transport tube rack cap 100 to sit on top of a strip or block of specimen transport tubes.

The top side of the specimen transport tube rack cap 100 of FIG. 2b has an access hole 301a-n that lines up with the middle of each specimen transport tube. The access hole 301a-n is the exact diameter of the pipette tip being used. This access hole 301a-n allows for the passage of the pipette tip into the tube, while at the same time securing the swab from being lifted or flung out of the tube.

The specimen transport tube rack cap 100 has several characteristics that are improvements on currently available options. First, the portion of this specimen transport tube rack cap 100 that sits directly on the specimen tubes can be made to fit different sizes and types of transport tubes. Second, the number and spacing of specimen tubes on liquid handler carriers and universal racks varies (i.e., strips of 24 or 32 tubes, blocks of 24, 48 and 96 tubes), and this specimen transport tube rack cap 100 can be adjusted to both the number and spacing of those variants. In addition, the center portion of each tube position 301a-n, which allows the passage of a pipette tip into a tube as shown in FIG. 2b, also can be adjusted to fit any pipette tip diameter. Lastly, this specimen transport tube rack cap 100 can be disinfected to allow for reuse.

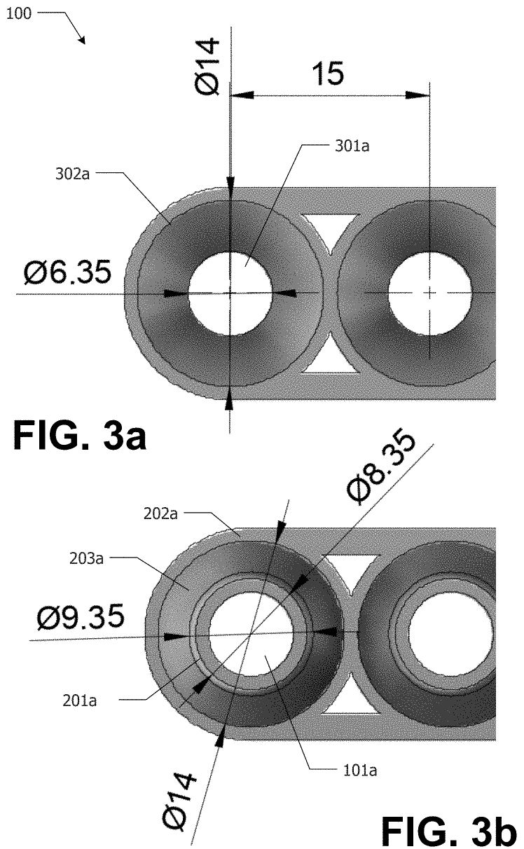

FIGS. 3a-b illustrate dimensions of an example embodiment of an article of manufacture providing a reusable specimen transport tube rack cap that secures specimen collection swabs inside of transport tubes according to the present invention. FIG. 3a shows dimensions of the top view of a specimen transport tube rack cap 100. The specimen transport tube rack cap 100 has access holes 301a-n in the center of each cap having an opening with a diameter of 6.35 mm. A sloping upward surface of the top of each cap rises to have a diameter of 14 mm. The sloping upward surface 303a-n is configured to guide a pipette into the transport tube to extract a sample contained herein. In this embodiment, the centers of each access hole 301a-n are spaced 15 mm apart in a row. The center of each access hole 301a-n may be spaced any distance apart to match the spacing of the transport tubes when arranged to be placed within an automated testing machine.

FIG. 3b shows dimensions of the bottom view of the specimen transport tube rack cap 100. The access hole 301a-n is seen in the center of each cap 101a-n and defined by an inner wall structure 201a-b that separates the access hole 301a-n from the specimen tube retention ridge 203a-n. The specimen tube retention ridge 203a-n is defined as the partially enclosed space between the inner wall structure 201a-n and the outer wall structure 202a-n of each cap 101a-n. A top edge of the specimen tube is enclosed within the specimen retention ridge 203a-n when the specimen transport tube rack cap 100 is placed onto a set of specimen tubes. In all cases. the specimen retention ridge 203a-n needs to be deep enough to engage the edge of the tubes so the specimen transport tube rack cap 100 stays on the tubes. In two example embodiments, the specimen retention ridge 203a-n have been shown to successfully engage the tubes with a depth of 3 mm deep and 6 mm. The depth of the specimen retention ridge 203a-n also is related to the depth of the cap that a pipette must pass as it is inserted into the specimen tubes. The depth of this area is not important as it serves no functional purpose. The specimen transport tube rack cap 100 may be made of ceramic, metal, or plastics as the specimen transport tube rack cap 100 is subjected to heat and steam in an autoclave or bleached when cleaned for reuse.. The most common materials in microbiology labs are metals and plastics. The outer wall structures 202a-n may be integrated into adjacent caps and any side support structures that combine multiple caps into a single row.

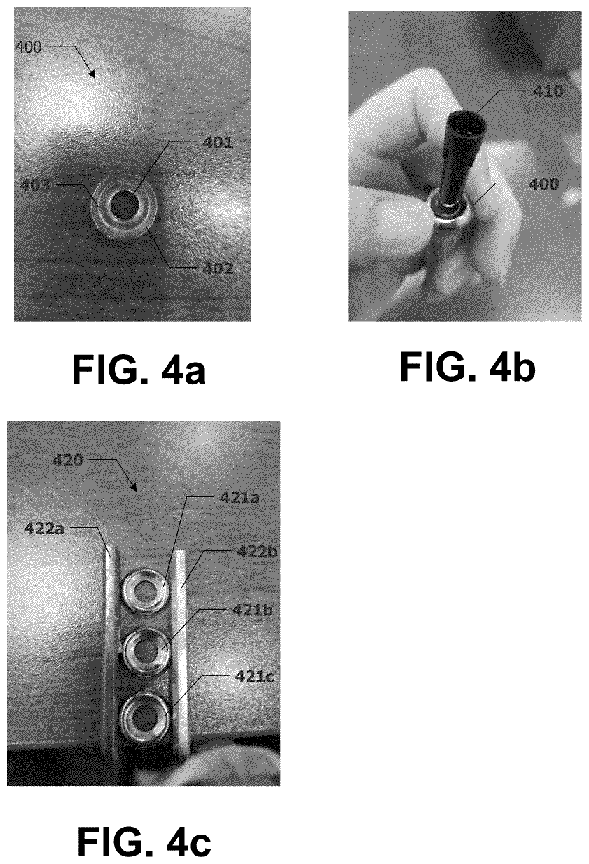

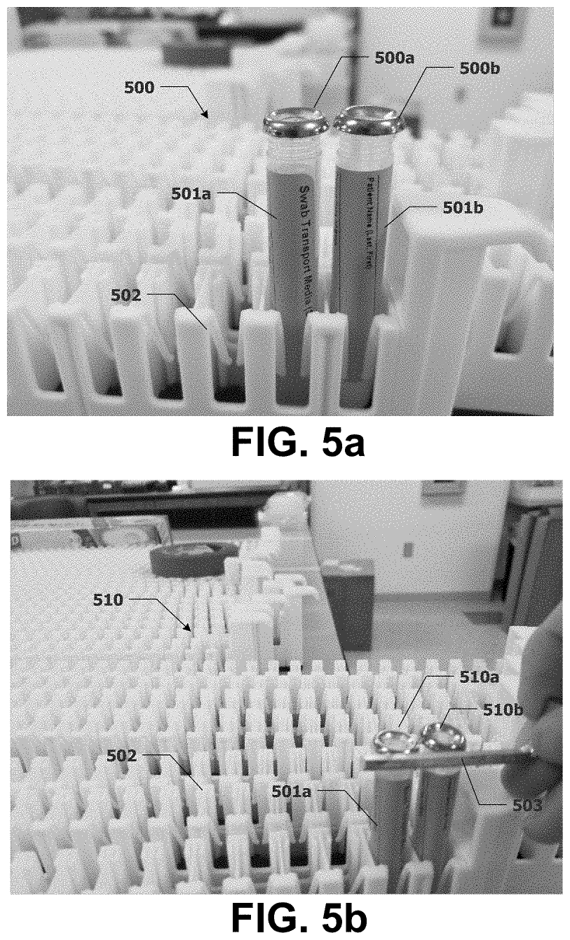

FIGS. 4a-c illustrate another embodiment of an article of manufacture providing a reusable specimen transport tube rack cap that secures specimen collection swabs inside of transport tubes according to the present invention. A second embodiment of the specimen transport tube rack cap 400 is shown in FIGS. 4a-c and FIGS. 5a-b. FIG. 4a shows an underside of a cap 400 having a specimen tube retention ridge 403 between an inner wall structure 401 and an outer wall structure 402. The single specimen tube cap 400 is made of metal in the embodiment of FIG. 4 that has been stamped to provide the wall structures and a specimen tube retention ridge 403.

FIG. 4b shows a pipette 410 inserted into a top side of the specimen tube cap 400 as it would be inserted to obtain a sample from within the specimen tube. The inner wall structure 401 is sized to permit an appropriate portion of the pipette to be inserted through the specimen tube cap 400 before the pipette becomes too wide to pass through the access hole 301. FIG. 4c shows a series of specimen tube caps 420 made from multiple specimen tube caps 421a-c that are held in place using support rods 422a-b that run parallel to each other on opposite sides of the multiple specimen tube caps 421a-c. In this embodiment, the metal multiple specimen tube caps 421a-c may be coupled to the support rods 422a-b using any known method of connecting the metal caps to metal rods, including welding, soldering, epoxy, and similar attachment mechanisms. The entire structure 420 may be formed as a single object from a mold or related mechanism as well.

FIGS. 5a-b illustrate transport tubes using an article of manufacture providing a reusable specimen transport tube rack cap that secures specimen collection swabs inside of transport tubes according to the present invention. FIG. 5a shows a pair of specimen tubes 501a-b upright in a specimen tube rack 502. Each of the of specimen tubes 501a-b is shown with a specimen tube cap 500a-b placed on top of the specimen tubes. The access holes 301a-n are centered over the top of the specimen tubes 501a-b to permit an automated processing machine to insert a pipette 410 into a specimen tube 501a-b to retrieve a sample for testing. FIG. 5b shows a similar specimen tube rack 502 having a pair of specimen tubes 502a-b with specimen tube caps 510a-b that are connected together by a support rod 503 in a manner disclosed above in reference to FIGS. 4a-c. As noted herein, the number and spacing of the specimen tube caps 510a-b may be made to match the number and spacing of the specimen tubes 501a-b when they are within the specimen tube rack 502.

Racks can be place on the tubes when the tubes are in racks, or blocks, after specimen transport tubes are removed. The placement of the rack can be done by hand or by programming of a liquid handler. The racks should be inspected to make sure that each rack has been placed on properly and are secure to the tubes. Racks can be removed for cleaning either by hand or by programing of a liquid handler.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture providing a reusable specimen transport tube rack cap, the reusable specimen transport tube rack cap comprises:
a top surface connecting a plurality of specimen tube caps in a row;
a bottom surface having a circular inner wall and a circular outer wall creating a specimen retention ridges defining a cap for each specimen tube; and
access hole through each reusable specimen transport tube rack cap between the inner wall and the outer wall for providing access for a pipette into a specimen tube.

2. The reusable specimen transport tube rack cap according to claim 1, wherein the specimen retention ridges having a depth between 3 mm and 6 mm to engage a top surface of each specimen tube.

3. The reusable specimen transport tube rack cap according to claim 1, wherein the reusable specimen transport tube rack cap is cleaned for reuse in an autoclave.

4. The reusable specimen transport tube rack cap according to claim 3, wherein the reusable specimen transport tube rack cap is cleaned for reuse using bleach.

5. The reusable specimen transport tube rack cap according to claim 4, wherein the reusable specimen transport tube rack cap is made of a material comprising one of the following:
ceramics, metal, and plastic.
